(19) United States
(12) Patent Application Publication
(10) Pub. No.: US 2008/0316308 A1
(43) Pub. Date: Dec. 25, 2008

(54) Method and Device for Programming an Image Acquisition System

(76) Inventors: Christophe Roger Spinello, Saint-Hilaire-Du-Touvet, (FR); Jean-Pierre Michel Ancelin, Saint-Nazaire-Les-Eymes (FR)

Correspondence Address: YOUNG & THOMPSON, 209 Madison Street, Suite 500, ALEXANDRIA, VA, 22314, US

(21) Appl. No.: 10/588,494

(22) PCT Filed: Feb. 4, 2005
(86) PCT No.: PCT/FR2005/000261

§ 371 Date: Oct. 19, 2006

(30) Foreign Application Priority Data
Feb. 5, 2004 (FR) 0401118

(51) Int. Cl. H04N 7/18

(52) U.S. Cl. 348/143; 348/E07.085

(57) ABSTRACT

Method and device for programming an image acquisition system including a camera having a field of vision and a processor of images taken by the camera, in order to define at least one detection area in the field of vision of the camera, in which a sending device (21) is placed in at least one position in the field of vision of the camera and the sending device sends at least one initialization light signal having predetermined light characteristics towards the camera when it is in the position. The content of the images (9a) obtained from the camera is analyzed so as to recognize the initialization signal and the signal is located by its coordinates in the images obtained from the camera. A program predetermines at least one detection area (15) in the field of vision of the camera based on the coordinates of the initialization signal.

The present invention relates to the field of image acquisition systems comprising a camera and means of processing and analyzing the content of the images taken by this camera.

Such systems are commonly used in particular in the field of road traffic control and monitoring and in the field of surveillance of particular spaces for the protection of people and goods.

Given the fact that the cameras have a predetermined field of vision, it is often desirable to carry out an analysis of the images in a reduced, so-called detection, field of vision, included in the field of vision of the camera. Currently, such a detection field is determined by creating a detection area in the images obtained from the camera according to the following methods.

In a first case, the detection area is electronically predefined in the image obtained from the camera and the detection field corresponding to this area is adjusted by orienting the camera. Unfortunately, the area covered by the field of vision corresponding to the predefined detection area varies according to the orientation of the camera and the setting of the orientation of the camera can only be approximate.

In a second case, the image acquisition system has associated with it a screen displaying the images obtained from the camera, and after having fixed the position of the camera, a detection area is programmed in the displayed image. Such a method entails installing and using additional display equipment that has to be connected to the image acquisition system, which can be difficult when the image acquisition system is placed at height and difficult to access.

The object of the present invention is to propose a method and a device for programming an image acquisition system in order to define at least one detection area in the field of vision of the camera, that can be performed in a way that is accurate and can be scaled without requiring the use of a display screen.

The primary subject of the present invention is a method of programming an image acquisition system comprising image reception or detection means, such as a camera, having a field of vision and means of processing the images taken by said camera, in order to define at least one detection area in the field of vision of the camera.

According to the present invention, this method consists in placing a sending device in at least one position in the field of vision of the camera and in activating the sending device so that it sends at least one electromagnetic initialization signal or radiation, such as a light signal, having predetermined characteristics, towards the camera when it is in said at least one position, in analyzing the content of the images obtained from the camera so as to recognize said initialization signal; in locating said signal by its coordinates in the images obtained from the camera; and in defining, according to a predetermined program, at least one detection area in the field of vision of the camera based on said coordinates of said initialization signal.

According to the present invention, the method can advantageously consist in placing a sending device in turn in at least two positions in the field of vision of the camera and in activating in turn the sending device so that it sends initialization signals having predetermined light characteristics towards the camera when it is in said positions, in analyzing the content of the images obtained from the camera so as to recognize said initialization signals, in locating these signals by their coordinates in the images obtained from the camera, and in defining, according to a predetermined program, at least one detection area in the field of vision of the camera based on said coordinates of said initialization signals.

According to the present invention, the method can advantageously consist in prestoring initialization data corresponding to said at least one initialization signal, in comparing the measured data corresponding to at least one point of the images received with this prestored initialization data and in determining or computing the coordinates of at least one initialization point in the images received when the measured data corresponding to this point is equal or roughly equal to the stored initialization data.

According to the present invention, the method can advantageously consist in defining at least one detection area in the field of vision of the camera based on the coordinates of at least one received initialization signal, the extent and position of which relative to these coordinates are predefined.

According to the present invention, the method can advantageously consist in defining a detection area in the field of vision of the camera based on the coordinates of two received initialization signals, located at least on one side of the line passing through the points corresponding to these coordinates.

According to the present invention, the method can advantageously consist in defining a polygonal detection area in the field of vision of the camera based on the coordinates of at least three received initialization signals, the sides of which pass through the points corresponding to these coordinates.

According to the present invention, said initialization signals preferably have different predetermined light characteristics.

According to the present invention, the method can advantageously consist in analyzing the content of the images received by digital filtering or thresholding.

According to the present invention, each initialization signal is preferably a light signal sent according to a predetermined modulating frequency and/or a predetermined chroma.

Another subject of the present invention is a device for programming an image acquisition system comprising image reception or detection means, such as a camera, having a field of vision and means of processing the images taken by said camera.

According to the present invention, this device comprises at least one mobile sending device suitable for sending at least one electromagnetic initialization signal or radiation, such as a light signal, having at least one predetermined characteristic, towards the camera and the image acquisition system comprises means of recognizing said at least one initialization and location signal to define the coordinates of said at least one initialization signal in the images obtained from this camera, and means for defining, according to a predetermined program, at least one detection area in the field of vision of the camera based on said coordinates of said at least one initialization signal.

According to the present invention, the camera is preferably a video camera and said recognition and location means preferably comprise at least one digital filtering or thresholding means in order to compare prestored data with data corresponding to the points of the video signal.

According to the present invention, the image acquisition system preferably comprises notification means and means for activating these notification means when the coordinates corresponding to said at least one initialization signal are acquired.

According to the present invention, the device preferably comprises sending and receiving means associated with the mobile sending device and sending and receiving means associated with said image acquisition system, suitable for exchanging functional signals.

According to the present invention, the device preferably comprises synchronization means for synchronizing said mobile sending device and said image acquisition system using synchronization signals exchanged via said sending and receiving means.

According to the present invention, the device preferably comprises acknowledgement means at least for signaling the end of the definition of said coordinates and/or the end of the definition of said at least one detection area.

Another subject of the present invention is an appliance for the surveillance of at least one predetermined area.

This appliance comprises a programming device as defined above and is programmed according to the method as defined above.

The present invention will be better understood by studying an image acquisition and processing system associated with a device for sending light signals, described by way of non-limiting examples illustrated by the drawing in which:

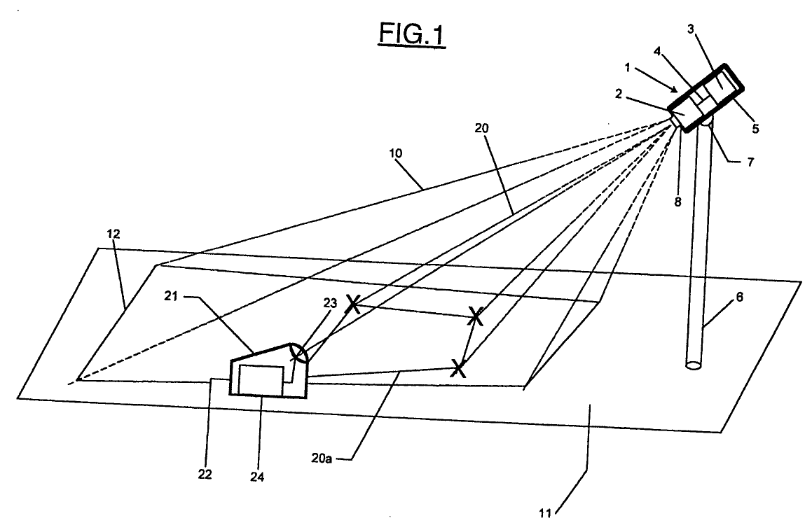

FIG. 1 represents a perspective view, in situ, of an image acquisition and processing system according to the invention,

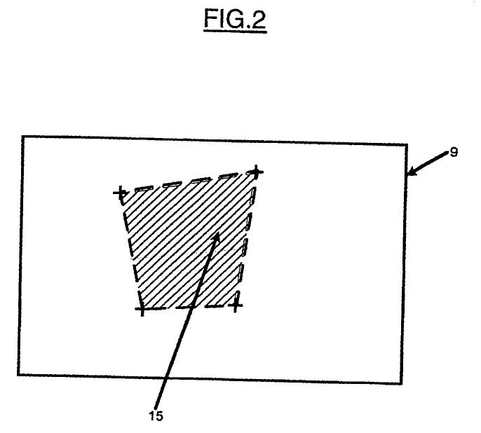

FIG. 2 represents an image analyzed by said system,

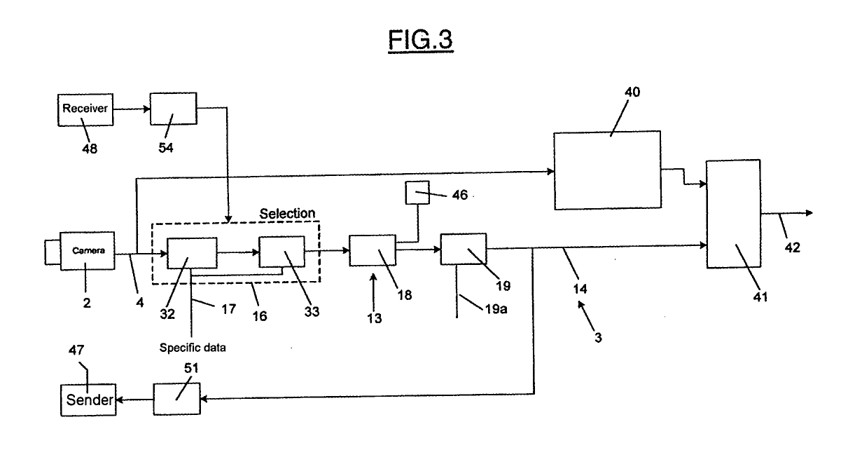

FIG. 3 represents an electronic diagram of said system,

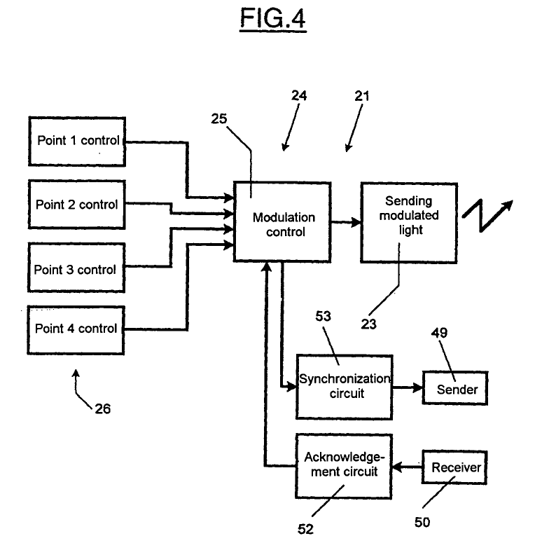

FIG. 4 represents an electronic diagram of said sending device,

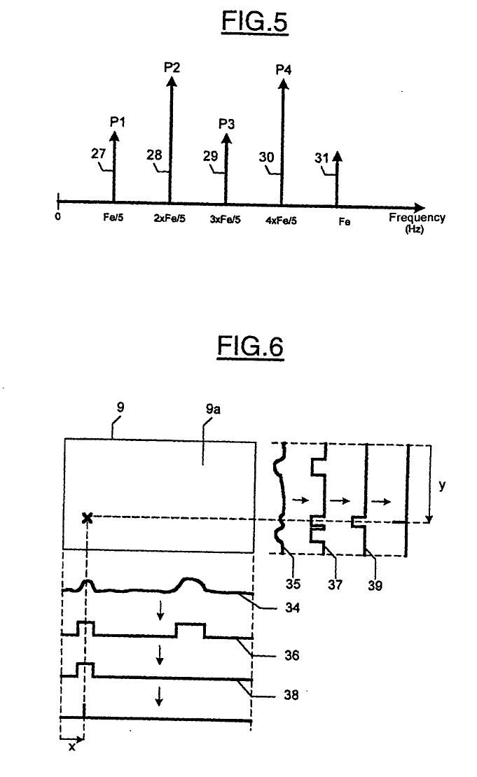

FIG. 5 represents a frequency graph,

FIG. 6 represents a selection graph,

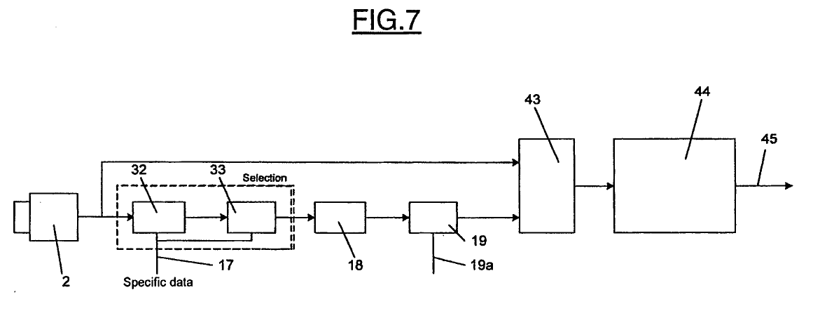

and FIG. 7 represents an electronic diagram of an embodiment variant of said system.

Referring to FIG. 1, there is represented an image acquisition system 1 which comprises a video camera 2 linked, via a connecting line 4, to an electronic system 3 for acquiring and processing images taken by the camera 2.

This assembly is installed in a sealed box 5 mounted on the top end of a post 6, via an adjustable articulation 7, known per se, this box 5 having an aperture 8 through which the camera 2 sees.

In the example shown, the box 5 is set so that the main axis of the field of vision of the camera 2 is oriented towards the ground 9, roughly at 45°.

As shown in FIG. 2, the vision video sensor 9 of the camera 2 is rectangular, such that the overall field of vision 10 of this camera determines, on the ground 11, given that the latter is roughly horizontal, roughly a trapezoid 12, the small side of which is located on the side of the post 6.

As can be seen in FIG. 3, the electronic system 3 for acquiring and processing images comprises an electronic programming device 13 which receives, via the line 4, the data relating to the images taken by the camera 2, and which delivers, over an output line 14, the data relating to a detection area 15 included in the images obtained from the camera 2.

This programming device 13 comprises an electronic selection circuit 16, suitable for analyzing the content of the images obtained from the camera 2, so as to recognize initialization light signals Si in the images taken by the camera 2 according to specific data programmed by an input 17 and corresponding to predetermined light characteristics.

The programming device 13 also comprises an electronic computation circuit 18 suitable for computing the coordinates of the points in the images obtained from the camera 2, for which the data correspond to said programmed specific data.

The programming device 13 also comprises an electronic definition circuit 19 programmed via an input 19a to define a detection area 15 in the images obtained from the camera, based on said coordinates of said initialization signals.

This detection area 15 corresponds to a field of vision 20 included in the overall field of vision 9 of the camera 2, the projection of which constitutes a detection surface area 20a on the ground 11 included in the overall surface area 12.

As shown in FIG. 1, the acquisition and processing system 2 can have associated with it a mobile sending device 21, portable or movable, which comprises, carried by a box 22, a sender 23 of light signals and an electronic circuit 24 suitable for supplying this sender with signals containing data to be sent.

As shown in FIG. 4, the electronic circuit 24 comprises a modulation circuit 25 linked to the sender 23 and a selector 26 linked to the programmed modulation circuit 25, suitable for an operator to choose a particular light signal from a number of light signals to be sent respectively having predetermined light characteristics that can be recognized by the programming device 13 of the acquisition and processing system 2.

To fix a particular detection area 15, the operator places the sending device 21 in turn in required positions on the overall vision surface area 12, by orienting his sender 23 towards the camera 2 and activates in turn the selector 26 so that the latter sends modulated light signals having predetermined light characteristics resulting from the programming of the modulation circuit 24.

With the camera 2 seeing and capturing these particular light signals, the programming device 13 of the acquisition and processing system 2 fixes the detection area 20.

In a particular embodiment, as shown in FIG. 5, the sending device 21 can be programmed to send four light signals Si1, Si2, Si3 and Si4, preferably of the same chroma, for example red, and of different modulating frequencies 27, 28, 29 and 30, for example frequencies equal to ⅕th, ⅖ths, ⅗ths and ⅘ths of the frequency 31 for acquisition of the video signal by the camera 2.

In this case, the selection circuit 16 of the programming circuit 13 of the acquisition system 3 is programmed to recognize such light signals and locate them in the images obtained from the camera 2, and can comprise a digital double-thresholding stage 32 for chroma, followed by a digital dual-filter 33 for frequencies.

As illustrated in FIG. 6, the programming circuit 13 can then analyze in turn each overall image 9a obtained from the camera 2 as follows.

The stage 32 adds up, on the y and x axes, the white levels contained in the corresponding pixels of the image 9a and thus constructs curves 34 and 35. On the x and y axes, it selects the points for which the white levels are greater than a predetermined level and constructs pulsed curves 36 and 37.

The dual-filter 33 scans the points included in the pulses of the curves 36 and 37. It selects the points in which it recognizes one of said frequencies 27, 28, 29 and 30 and constructs the curves 38 and 39. These curves 38 and 39 respectively contain a single pulse which corresponds to an initialization light signal sent.

Receiving the curves 38 and 39, the computation circuit 18 computes the x and y coordinates of the middle of the pulses that contain the curves 38 and 39 and delivers to the definition circuit 19 these coordinates and the associated recognized frequency.

The result of the above is that, when an operator places the sending device 21 in turn in four different positions E1, E2, E3 and E4 on the surface area 12, illustrated in FIG. 1, and by having it send in turn the four light signals Si1, Si2, Si3 and Si4, the definition circuit 19 receives four groups of data D1, D2, D3 and D4 corresponding to four points P1, P2, P3 and P4 of the images 9a obtained from the camera 2, visible in FIG. 2 and respectively containing the coordinates of these points and the associated frequencies.

The definition circuit 19 can be programmed to construct a polygon, the sides of which pass through the points P1, P2, P3 and P4 for which the surface area constitutes a detection area 15.

Should the operator activate the sending device 21 so that it sent one of the abovementioned initialization signals, the definition circuit 19 would redefine a new polygon by taking into account the location and the frequency of this signal by replacing the identical signal previously detected.

As shown in FIG. 3, the acquisition and processing system 3 comprises an electronic circuit 40 for processing the overall images obtained from the camera 2 and corresponding to the field of vision 10, which analyzes the content of these images according to a predetermined program, to extract analysis data from them.

Numerous image analysis programs, for example shape recognition programs, are known per se.

Such analysis data, at the same time as the data corresponding to the definition of the detection area derived from the definition circuit 19, is delivered to an electronic decision circuit 41 which delivers at its output 42 only the analysis data contained in the detection area 15 that corresponds to the detection field 20, by cutting along the sides of the polygon defined by the points P1, P2, P3 and P4.

In the variant represented in FIG. 7, the data corresponding to the content of the images obtained from the camera 2, at the same time as the data corresponding to the definition of the detection area obtained from the definition circuit 19, is delivered to an electronic cutting circuit 43 which delivers to an electronic processing circuit 44 only the data of the images contained in the detection area 15, this electronic processing circuit 44 analyzing the content of the image portions according to a predetermined program to extract from them analysis data that it delivers to its output 45.

In a variant, the image acquisition and processing system 3, instead of being continually in an initialization light signal detection state, as described previously, could be adapted to be placed in a detection area programming state, then in an image processing state after programming such an area.

The result of the above is that the image acquisition and processing system 3 can be programmed in situ and is suitable for delimiting a specific detection area 15, corresponding to a specific detection field 20 contained in the overall field of vision 10 of the camera 2, that the operator programs using the sending device 21 directly in the field by placing this device 21 in positions of his choice.

Naturally, the image acquisition and processing system 3 and the sending device 21 could be programmed to define a detection area located on one side of a separation line plotted on the basis of two points, the coordinates of which would be determined by two initialization light signals.

Furthermore, the image acquisition and processing system 3 could be programmed to define at least one detection area on the basis of the coordinates of a single point, with which there would be associated a predetermined surface area of predetermined shape and dimensions.

They could also be programmed to define polygonal detection areas, for which the number of points to define their sides could be chosen at will.

They could even be programmed to define a number of detection areas in the field of vision of the same camera based on the coordinates of one or more points.

Moreover, in the interests of programming security for the user, the image acquisition system 3 can include a light or sound notification device 46 activated by the computation circuit 19 when the coordinates corresponding to each initialization signal are acquired.

By referring again to FIG. 3, it can be seen that the image acquisition system 3 can also include a sender 47 and a receiver 48, for example of radiofrequency signals, and, by referring again to FIG. 4, it can be seen that the mobile sending device 21 can also include a sender 49 and a receiver 50 of radiofrequency signals for example, these senders and receivers being designed to intercommunicate to exchange information.

In particular, the line 14 from the image acquisition system 3 can be linked to an acknowledgement circuit 51 linked to the sender 47, and the receiver 50 can be linked to the modulation control circuit 25 via an acknowledgement circuit 52, so as to notify this circuit 25 that the definition of the coordinates of the points has been executed correctly and/or that the definition of a detection area has been executed correctly. Because of this, the mobile sending device 21 could also comprise a sound or light notification means to notify the operator that these operations have been executed correctly.

Furthermore, the modulation control circuit 25 can be linked to the sender 49 via a synchronization circuit 53 and the receiver 48 can be linked to the selection circuit 16 via a synchronization circuit 54 so as to synchronize the sending of the initialization signals and the processing of the images received by the camera 2.

Finally, as a general rule, the initialization signals sent to the camera could be visible or invisible signals.

The present invention is not limited to the examples described. Many variants are possible without departing from the scope defined by the appended claims.

1. A method of programming an image acquisition system comprising image reception or detection means, such as a camera, having a field of vision and means of processing the images taken by said camera, in order to define at least one detection area in the field of vision of the camera, characterized in that it consists:
in placing a sending device (21) in at least one position in the field of vision of the camera and in activating the sending device so that it sends at least one electromagnetic initialization signal or radiation, such as a light signal, having predetermined characteristics, towards the camera when it is in said at least one position,
in analyzing the content of the images (9a) obtained from the camera so as to recognize said initialization signal, in locating said signal by its coordinates in the images obtained from the camera,
and in defining, according to a predetermined program, at least one detection area (15) in the field of vision of the camera based on said coordinates of said initialization signal.

2. The programming method as claimed in claim 1, characterized in that it consists in placing a sending device (21) in turn in at least two positions in the field of vision of the camera and in activating in turn the sending device so that it sends initialization signals having predetermined light characteristics towards the camera when it is in said positions, in analyzing the content of the images (9a) obtained from the camera so as to recognize said initialization signals,
in locating these signals by their coordinates in the images obtained from the camera,
and in defining, according to a predetermined program, at least one detection area (15) in the field of vision of the camera based on said coordinates of said initialization signals.

3. The programming method as claimed in claim 1, characterized in that it consists in prestoring initialization data corresponding to said at least one initialization signal, in comparing the measured data corresponding to at least one point of the images received with this prestored initialization data and in determining or computing the coordinates of at least one initialization point in the images received when the measured data corresponding to this point is equal or roughly equal to the stored initialization data.

4. The programming method as claimed in claim 1, characterized in that it consists in defining at least one detection area in the field of vision of the camera based on the coordinates of at least one received initialization signal, the extent and position of which relative to these coordinates are predefined.

5. The programming method as claimed in claim 1, characterized in that it consists in defining a detection area in the field of vision of the camera based on the coordinates of two received initialization signals, located at least on one side of the line passing through the points corresponding to these coordinates.

6. The programming method as claimed in claim 1, characterized in that it consists in defining a polygonal detection area in the field of vision of the camera based on the coordinates of at least three received initialization signals, the sides of which pass through the points corresponding to these coordinates.

7. The programming method as claimed in claim 1, characterized in that said initialization signals have different predetermined light characteristics.

8. The programming method as claimed in claim 1, characterized in that it consists in analyzing the content of the images received by digital filtering or thresholding.

9. The programming method as claimed in claim 1, characterized in that each initialization signal is a light signal sent according to a predetermined modulating frequency and/or a predetermined chroma.

10. A device for programming an image acquisition system comprising image reception or detection means, such as a camera, having a field of vision and means of processing the images taken by said camera, characterized in that it comprises
at least one mobile sending device (21) suitable for sending at least one electromagnetic initialization signal or radiation, such as a light signal, having at least one predetermined characteristic, towards the camera,
and in that the image acquisition system (3) comprises means (13) of recognizing said at least one initialization and location signal to define the coordinates of said at least one initialization signal in the images obtained from this camera
and means (19) for defining, according to a predetermined program, at least one detection area (15) in the field of vision of the camera based on said coordinates of said at least one initialization signal.

11. The programming device as claimed in claim 10, characterized in that the camera (2) is a video camera and in that said recognition and location means comprise at least one digital filtering or thresholding means (16) in order to compare prestored data with data corresponding to the points of the video signal.

12. The programming device as claimed in claim 10, characterized in that the image acquisition system comprises notification means (46) and means for activating these notification means when the coordinates corresponding to said at least one initialization signal are acquired.

13. The programming device as claimed in claim 10, characterized in that it comprises sending and receiving means (49, 50) associated with the mobile sending device (21) and sending and receiving means (47, 48) associated with said image acquisition system (3), suitable for exchanging functional signals.

14. The programming device as claimed in claim 13, characterized in that it comprises synchronization means (53, 54) for synchronizing said mobile sending device (12) and said image acquisition system (13) using synchronization signals exchanged via said sending and receiving means.

15. The programming device as claimed in one claim 13, characterized in that it comprises acknowledgement means (51, 52) at least for signaling the end of the definition of said coordinates and/or the end of the definition of said at least one detection area.

16. An appliance for the surveillance of at least one predetermined area, characterized in that it comprises a programming device for programming an image acquisition system comprising image reception or detection means, such as a camera, having a field of vision and means of processing the images taken by said camera, characterized in that it comprises
at least one mobile sending device (21) suitable for sending at least one electromagnetic initialization signal or radiation, such as a light signal, having at least one predetermined characteristic, towards the camera,
and in that the image acquisition system (3) comprises means (13) of recognizing said at least one initialization and location signal to define the coordinates of said at least one initialization signal in the images obtained from this camera
and means (19) for defining, according to a predetermined program, at least one detection area (15) in the field of vision of the camera based on said coordinates of said at least one initialization signal;
wherein the programming device is programmed according to the method as claimed in claim 1.

17. The programming method as claimed in claim 2, characterized in that it consists in prestoring initialization data corresponding to said at least one initialization signal, in comparing the measured data corresponding to at least one point of the images received with this prestored initialization data and in determining or computing the coordinates of at least one initialization point in the images received when the measured data corresponding to this point is equal or roughly equal to the stored initialization data.

18. The programming method as claimed in claim 2, characterized in that it consists in defining at least one detection area in the field of vision of the camera based on the coordinates of at least one received initialization signal, the extent and position of which relative to these coordinates are predefined.

19. The programming method as claimed in claim 3, characterized in that it consists in defining at least one detection area in the field of vision of the camera based on the coordinates of at least one received initialization signal, the extent and position of which relative to these coordinates are predefined.

20. The programming method as claimed in claim 2, characterized in that it consists in defining a detection area in the field of vision of the camera based on the coordinates of two received initialization signals, located at least on one side of the line passing through the points corresponding to these coordinates.
